(19) United States
(12) Patent Application Publication
(10) Pub. No.: US 2011/0173044 A1
(43) Pub. Date: Jul. 14, 2011

(54) Possible worlds risk assessment system and method

(76) Inventors: Michael D. Howard, Westlake Village, CA (US); Bradford W. Miller, Narragansett, RI (US)

(21) Appl. No.: 12/655,996

(22) Filed: Jan. 12, 2010

(51) Int. Cl. G06Q 10/00; G06N 5/02

(52) U.S. Cl. 705/7.28; 706/52

(57) ABSTRACT

A possible worlds risk assessment system including a planning subsystem configured to create a plan for each risk source which threatens a defended area in one or more possible worlds. A clustering subsystem may be configured to cluster states of each plan for each risk source by spatial locality to generate a risk source slice for each plan. Each risk source slice may be partitioned into cells representing the risk to the defended area in the one or more possible worlds. A risk assessment subsystem may be configured to combine each corresponding cell of each risk source slice to generate a risk assessment slice which includes an assessment of the risk associated with each cell of each risk source slice to provide a unified total situational assessment of the risk to the defended area. A data grid may be configured to store each risk source slice and the risk assessment slice.

### FIELD OF THE INVENTION

The subject invention relates generally to planning systems and more particularly to a possible worlds risk assessment planning system and method which can accommodate multiple possible worlds.

### BACKGROUND OF THE INVENTION

Some conventional adversarial planning systems plan a friendly course of action against an enemy intent. Typically, a certain enemy situation and intent and a posited plan are generated for a specific possible world. Since the world is only partially observable, a possible world is one possible assignment of values to variables that define the state of the world insofar as it affects the friendly and enemy forces. In order to consider a different possible world (e.g., a different enemy situation and intent), conventional systems typically need to separately generate another plan for the new possible world. See, e.g., Boutilier et al., “Decision Theoretic Planning: Structural Assumptions and Computational Leverage”, Journal of AI Research (JAM), (1999), incorporated by reference herein. Such planning systems may also lack any built-in mechanism to compare and combine independently generated plans. Thus, conventional adversarial planning systems may not provide the tools needed to analyze and prepare for many different scenarios at once.

Stochastic game systems are one type of adversarial planning system which may use partially observable Markov decision processes (POMPDs) to develop a probabilistic plan for an enemy force, a neutral force, and a friendly force. The plan developed by such systems is a Markov decision problem in which, at each time step, each force has a probability distribution over actions that the force can take. The plan selects each action according to a utility metric. See, e.g., Shen et al., “An Adaptive Markov Game Model for Threat Intent Inference”, 2007 IEEE Aerospace Conference, 3-10 Mar. 2007, incorporated by reference herein. Conventional planning systems which use POMPDs generally use mathematical models of sequential decision problems that accommodate actions with uncertain effects. But, such systems may not generate multiple possible plans for any of the forces and consider them all at the same time. In other words, these planning systems may only develop a plan for one possible world and plan for that possible world.

### BRIEF SUMMARY OF THE INVENTION

In one aspect, a possible worlds risk assessment system apparatus is featured including a planning subsystem configured to create a plan for each risk source that threatens a defended area in one or more possible worlds. A clustering subsystem is configured to cluster states of each plan for each risk source by spatial locality to generate a risk source slice for each plan. Each risk source slice is partitioned into cells representing the risk to the defended area in the one or more possible worlds. A risk assessment subsystem is configured to combine each cell of each risk source slice to generate a risk assessment slice which includes an assessment of the risk associated with each cell of each risk source slice to provide a unified total situational assessment of the risk to the defended area across the one or more possible worlds. A data grid is configured to store each risk source slice and the risk assessment slice.

In one embodiment, each cell of each risk source slice may include a probabilistic representation of each risk source for each plan. The risk assessment slice may be partitioned into cells. The risk assessment subsystem may evaluate each cell of each risk source slice to determine a threat risk assessment for each cell. The risk assessment subsystem may combine evidence from matching cells in each risk source slice into an appropriate cell of the risk assessment slice. The data grid may include a multi-dimensional data structure having a plurality of levels corresponding to each risk source slice and the risk assessment slice. The planning subsystem may include a probabilistic planner. The planning subsystem may include a partially observable Markov decision process (POMPD) planner. The partially observable Markov decision process planner may be configured to use stochastic game analysis to compute a plan for each risk source. The risk source slice and the risk assessment slice may be partitioned into uniform-shaped cells. The risk source slice and the risk assessment slice may be partitioned into non uniform-shaped cells.

In another aspect, a method for possible worlds risk assessment is featured, the method including creating a plan for each risk source which threatens a defended area in one or more possible worlds. States of each plan for each risk source are clustered by spatial locality to generate a risk source slice for each plan. Each risk source slice is partitioned into cells representing the risk to a defended area for each plan in each of the one or more possible worlds, where each cell of each risk source slice includes a probabilistic representation of each risk source for each plan. Each risk source slice is combined to generate a risk assessment slice which includes an assessment of the risk associated with each cell of each risk source slice to provide a situational assessment of the risk to a defended area. Each risk source slice and the risk assessment are stored in a data grid.

In one embodiment, the method may include the step of partitioning the risk assessment slice into cells. The method may include the step of evaluating each cell of each risk source slice to determine a threat risk assessment for each cell. The method may include the step of combining evidence from matching cells of each risk source slice into an appropriate cell of the risk assessment slice. The method may include the step of storing each risk source slice and the risk assessment slice in different levels of the data grid.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIGS. 1A and 1B are schematic three-dimensional views showing one embodiment of the possible worlds risk assessment system of this invention;

FIG. 2A is a schematic top view showing one example of a threat to a defended area in one possible world;

FIG. 2B is a schematic top view showing another example of a threat to a defended area in a different possible world;

FIG. 2C is a schematic top viewing showing one example of the combined risk landscape for the threats in the possible worlds shown in FIGS. 2A and 2B;

FIG. 3 depicts an example of the clustering of states of a single cell of one of the risk source slices shown in FIG. 1; and

FIG. 4 depicts an example of the combination of evidence from one cell of each of the risk source slices shown in FIG. 1 used to determine the combined risk assessment in a cell of the risk assessment slice.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

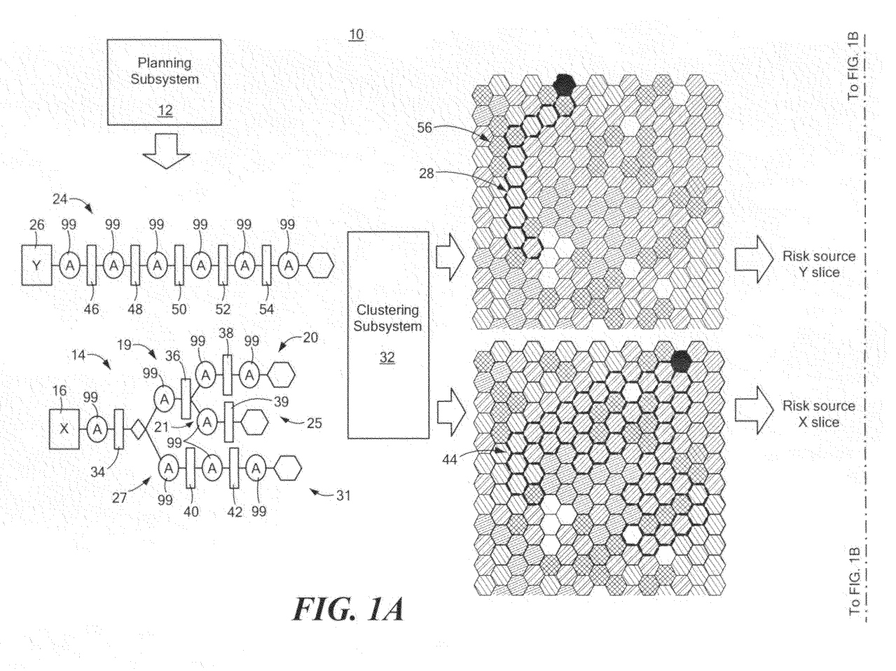

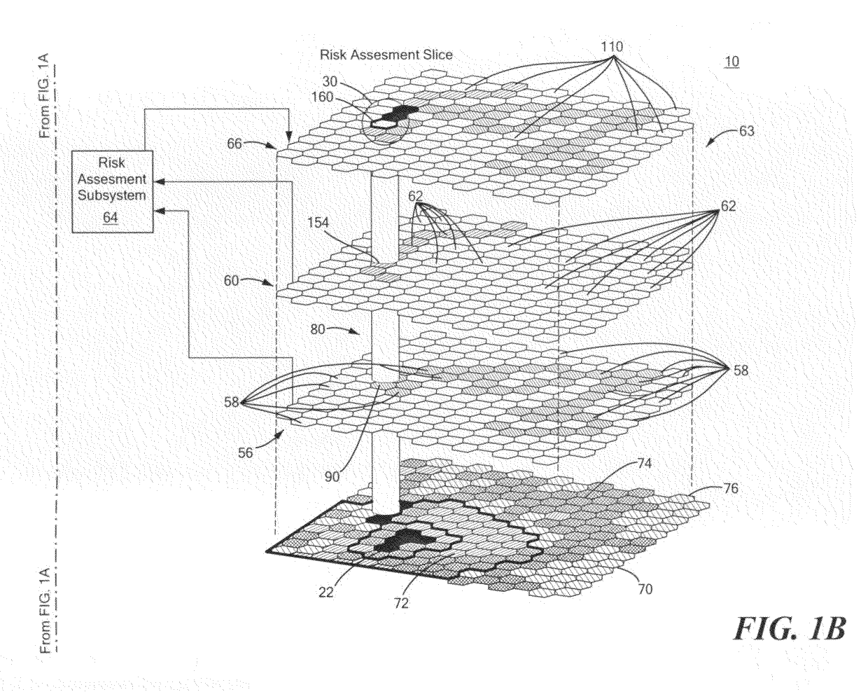

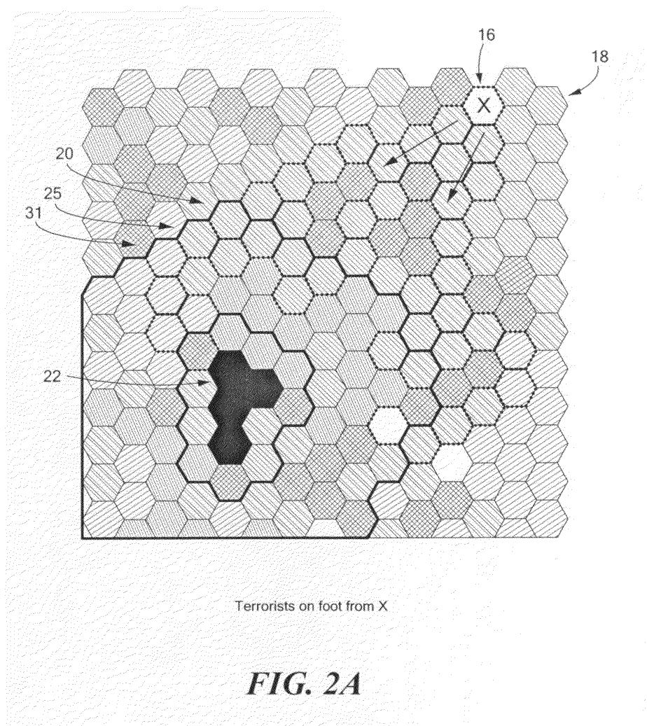

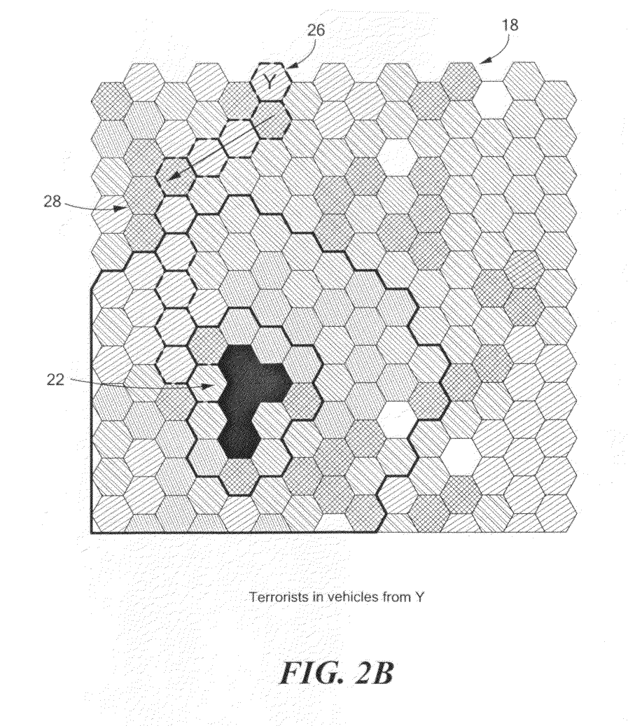

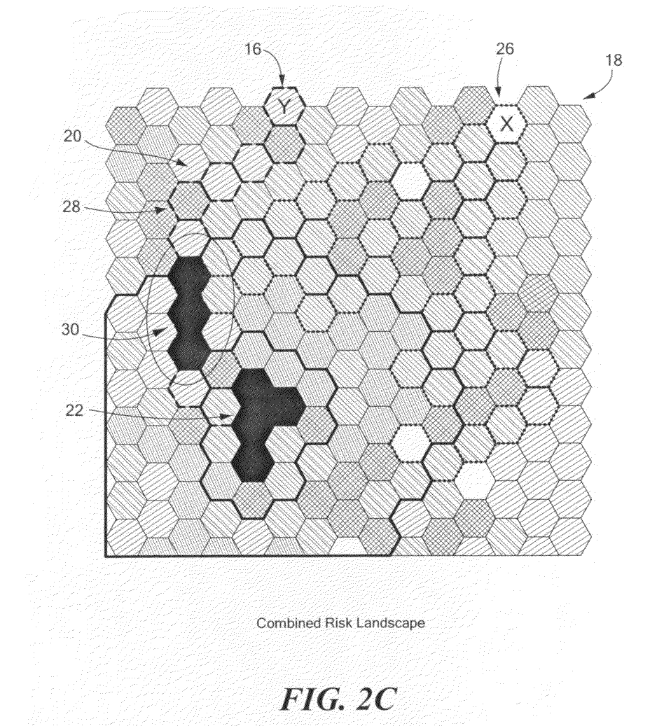

There is shown in FIGS. 1A and 1B an embodiment of a possible worlds risk assessment system 10 of this invention. System 10, FIG. 1A, includes planning subsystem 12 (e.g., an appropriately programmed processor or circuit) configured to create and output a plan for each risk source which threatens a defended area in one or more possible worlds. For example, planning subsystem 12 creates and outputs plan 14 for risk source 16, FIG. 2A, e.g. terrorists on foot at location X in terrain grid 18 in one or more possible worlds, e.g., possible world 20, 25, or 31, which threatens defended area 22, e.g., an airport, building, or similar type defended area. In this example, plan 14, FIG. 1A, may be considered to represent multiple possible worlds because it is a branching contingency plan where each branch could be considered a separate possible world. For example, branch 19 may represent possible world 20, branch 21 may represent possible world 25, and branch 27 may represent possible world 31. In this example, planning subsystem 12 also creates and outputs plan 24 for risk source 26, FIG. 2B, e.g. terrorists in vehicles at location Y in terrain grid 18 in possible world 28 which threaten defended area 22.

Clustering subsystem 32, FIG. 1A, (e.g., an appropriately programmed processor or circuit), receives as input the plans generated by planning subsystem 12. Clustering subsystem clusters the states of each plan for each risk source by spatial locality to generate and output a risk source slice for each plan. Preferably, each risk source slice is partitioned into cells which represent the risk to the defended area from each topographic area in any of one or more possible worlds. Each cell of each risk source slice represents that part of the plan for that risk source that takes place in that topographic area. In this example, clustering subsystem 32 receives as input plan 14 and clusters states 34, 36 and 38 along branch 19 in possible world 20 for risk source 16, FIG. 2A, state 39, FIG. 1A, along branch 21 in possible world 25 for risk source 16, and states 40 and 42 along branch 27 in possible world 31 for risk source 16 by spatial locality, shown at 44 (the cells having a dashed border), FIG. 1A, to generate and output a risk source slice 56, FIG. 1B. Risk source slice 56 is partitioned into topographic cells, of which representative cells are indicated at 58, each of which represents the risk to defended area, e.g., defended area 22, FIG. 2A. Each of cells in risk source slice 56 includes the probabilistic representation of risk source 16 for plan 14 in possible world 20, and/or possible world 25 and/or possible world 31.

Similarly, clustering subsystem 32, FIG. 1A, receives an input plan 24 and clusters states 46, 48, 52 and 54 of plan 24 for risk source 26 in possible world 28, FIG. 2B, by spatial locality, shown at 56 (the cells having a dashed border), FIG. 1A, to generate and output a risk source slice 60, FIG. 1B. Risk source slice 60 is also partitioned into cells, of which representative cells are indicated at 62, which represent the risk to a defended area 22, FIG. 2B. Preferably, each of the cells in risk source slice 60, FIG. 1B, includes the probabilistic representation of risk source 26 for plan 24 in possible worlds 28.

Data grid 63, e.g., a multi-dimensional data structure having a plurality of levels, stores risk source slice 56 and risk source slice 60. In this example, risk source slices 56 and 60 are stacked in a vertical arrangement.

After plans 14 and 24 are clustered into risk source slices 56 and 60, respectively, each cell of risk source slice 56 and each cell of risk source slice 60 will contain zero or more states from the respective plans. Each state takes place in some time and is associated with one or more actions that can be taken in that state. In this example, the actions associated with the various states of plans 14 and 24, FIG. 1A, are shown at 99. As used herein, a state is a description of a possible world. A state typically takes the form of a set of assertions about relevant facts. Usually, since the possible world is dynamically changing, a state description includes the time period over which it holds. The state could also be an instantaneous snapshot in time. Each action of each plan 14, 24 is rated by planning subsystem 12 with an associated likelihood. Each cell of risk source slice 56 and each cell of risk source slice 60 are received as input by risk assessment subsystem 64 and evaluated by risk assessment subsystem 64 to determine a threat risk assessment for each cell to the respective risk source 16 and 20. Risk assessment subsystem 64 combines the likelihood that each action can threaten a protected area, e.g., protected area 22, FIGS. 2A and 2B, at each temporal period.

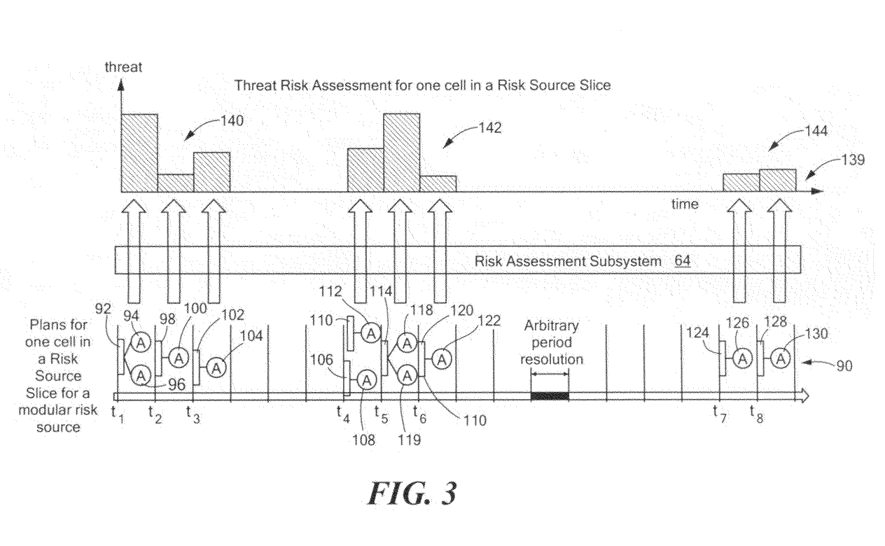

For example, graph 90, FIG. 3, shows one example of the computation of the threat assessment for one cell of risk source slice 56, FIG. 1B, e.g., cell 90. In this example, cell 90 includes state 92, FIG. 3, with actions 94 and 96 that risk source 16, FIG. 2A, may take if the possible world, e.g., possible world 20, 25 and/or 31, evolves to certain states at an arbitrary time, such as time t₁, FIG. 3. In this example, cell 92 may also include state 98 with action 100 at time t₂ that risk source 16 may take if a particular possible world evolves to certain states. Cell 92 also includes state 102 with action 104 at time t₃ that risk source 16 may take if a particular possible world evolves to certain states. Cell 92 may also include other states and actions that risk source 16 may take if a possible world evolves to certain states at arbitrary points in time, such as state 106 with action 108 and state 110 with action 112 at time t₄, state 114 with actions 118 and 119 at time t₅, and state 120 with action 122 at time t₆. In this example, at time t₄, there may be two states 106, 110, each having possible actions 108, 112, respectively, that risk source 16 may take. This represents two different possible worlds for plan 14. Cell 92 may also include state 124 with action 126 at time t₇, and state 128 with action 130 at time t₈. Risk assessment subsystem 64, FIGS. 1B and 3, (e.g., an appropriately programmed processor or circuit) generates and outputs a threat risk assessment which combines the likelihoods of each of the actions associated with each of the states discussed above at each temporal time period. Graph 139 shows an example of the threat risk assessment for cell 90 generated by risk assessment subsystem 64. Bars 140 show the calculated threat risk assessment for states and actions during the interval between t₁-t₃. Bars 142 show the calculated threat risk assessment for the states and actions during the interval between t₄-t₆. Bars 144 show the calculated threat risk assessment for states and actions during the interval between t₇ and t₈. Risk assessment subsystem 64 repeats this process for each cell of risk source slice 56, FIG. 1B, and each cell of risk source slice 60.

Risk assessment subsystem 64, FIG. 1B, combines evidence from each cell of the lower risk-specific slices of data grid 62, e.g., each cell of risk source slice 56 and each cell 62 of risk source slice 60 to generate and output risk assessment slice 66. Risk assessment slice is preferably partitioned into cells, of which exemplary cells are indicated at 110. The cell partitioning of each of the risk source slices and the risk assessment slice need to match, i.e., the terrain is partitioned using some desired tessellation, and then each risk source slice and risk assessment slice are tessellated identically with this desired tessellation. Risk assessment slice 66 is also preferably stored in data grid 62, e.g., on the top level as shown. The purpose of risk assessment slice 66 is to provide and output a risk assessment slice which provides an overall situational assessment of the risk to the defended area, e.g., defended area 22, FIGS. 2A and 2B, from the various risk sources, or threats, e.g., risk source 16 or risk source 26. The overall situational assessment is a normalized assessment of any threat that can occur from each area of the terrain. The overall situational assessment is preferably for each area of the terrain from which a threat can come, how dangerous the threat is, and when it may occur (normalized from all of the possible worlds). For illustration purposes only, a very active terrain location is shown for threat 16, FIG. 2A at location X and threat 26, FIG. 2B at location Y entering and leaving at different times and threatening defended area 22. In practice, many areas would have little or no expected activity. In this example, FIG. 2C represents the combined risk landscape in which evidence from risk source 16, FIG. 2A and risk source 26, FIG. 2B from risk source slice 56, FIG. 1, and risk source slice 60 are combined. The locations indicated at 30 are the only locations where the likelihoods from the possible worlds combine and are the most important area to cover with defensive resources.

Terrain slice 70, FIG. 1B, is for illustrative purposes only and is partitioned into cells which each represent a discrete geographical area. For example, terrain slice 70 may include cells indicated generally at 72 which indicate a lake or water, cells indicated generally at 74 which indicate grassy areas, and cells indicated generally at 76 which may indicate dirt or sand areas.

A vertical column, e.g., vertical column 80, FIG. 1B, at a particular terrain location contains the part of each of plans 14, 24, FIG. 1A, for each risk source 16, 26 related to that piece of terrain, regardless of time.

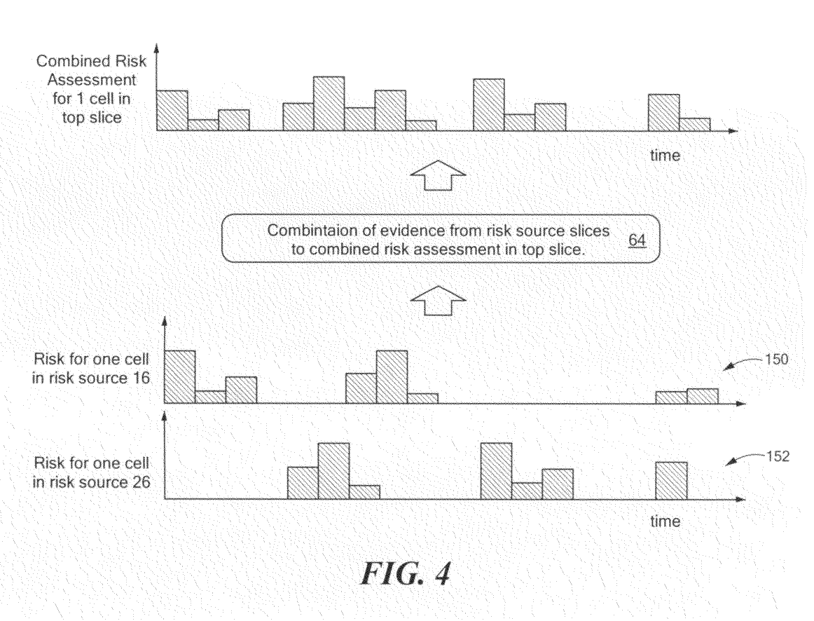

Graph 150, FIG. 4 shows an example of the threat risk assessment for cell 90, FIG. 1B, of risk source slice 56, as discussed above with reference to FIG. 3. Graph 152 shows an example of the threat risk assessment for one cell of risk source slice 60, FIG. 1B, e.g., cell 154. In this example, risk assessment subsystem 62 combines evidence from matching cell 90 of risk source slice 56 and cell 154 of risk source slice 60 into cell 160 of risk assessment slice 66. The process is repeated for each cell of risk source slice 56 and each cell of risk source slice 60. Thus, each cell of risk assessment slice 66 output by risk assessment subsystem 64 includes combined evidence from matching cells in the risk source slice below it. The resulting risk assessment slice 66 provides a situational assessment of the risk to the defended area. In this example, as discussed above, the locations indicated at 30 (also shown in FIG. 2C) are the only locations where the likelihoods from the possible worlds combine and are the most important area to cover with defensive resources. The result is possible worlds risk assessment 10 has effectively utilized probabilistic planning and has accommodated for more than one possible world to provide a situational assessment to the risk to defended area.

In one example, planning subsystem 12 may use an adversarial planner or probabilistic planner. Planner 12 may also utilize a partially observable Markov decision process (POMPD) planner. The POMPD planner may also use stochastic game analysis to complete the plan for each risk source.

In one embodiment, each of the cells of risk source slice 56, each of the cells of risk source slice 60, and each of the cells of risk assessment slice 66 are partitioned into uniform shaped cells, e.g., hexagon shaped cells as shown in FIG. 1B. In other examples, the cells may be partitioned into square, triangular, circular, or similar type uniform shaped cells. In other designs, the cells may be non-uniform shaped cells; e.g., designed to match topographic features in the terrain, or to match characteristics of the defended region such as vulnerable areas.

Planning subsystem 12, clustering subsystem 32, and risk assessment subsystem 64 of system 10, FIGS. 1A-1B, are preferably configured to execute the steps discussed herein which may be carried out by software operating on a computer or an equivalent device.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A possible worlds risk assessment system apparatus comprising:
a planning subsystem configured to create a plan for each risk source which threatens defended area in one or more possible worlds;
a clustering subsystem configured to cluster states of each plan for each risk source by spatial locality to generate a risk source slice for each plan, each risk source slice partitioned into cells representing the risk to the defended area in the one or more possible worlds;
a risk assessment subsystem configured to combine each corresponding cell of each risk source slice to generate a risk assessment slice which includes an assessment of the risk associated with each cell of each risk source slice to provide a unified total situational assessment of the risk to the defended area across the one or more possible worlds; and
a data grid configured to store each risk source slice and the risk assessment slice.

2. The system of claim 1 in which each cell of each risk source slice includes a probabilistic representation of each risk source for each plan.

3. The system of claim 1 in which the risk assessment slice is partitioned into cells.

4. The system of claim 3 in which the risk assessment subsystem evaluates each cell of each risk source slice to determine a threat risk assessment for each cell.

5. The system of claim 4 in which the risk assessment subsystem combines evidence from matching cells in each risk source slice into an appropriate cell of the risk assessment slice.

6. The system of claim 1 in which the data grid includes a multi-dimensional data structure having a plurality of levels corresponding to each risk source slice and the risk assessment slice.

7. The system of claim 1 in which the planning subsystem includes a probabilistic planner.

8. The system of claim 1 in which the planning subsystem includes a partially observable Markov decision process (POMPD) planner.

9. The system of claim 8 in which the partially observable Markov decision process planner is configured to use stochastic game analysis to compute a plan for each risk source.

10. The system of claim 1 in which the risk source slice and the risk assessment slice are partitioned into uniform-shaped cells.

11. The system of claim 1 in which the risk source slice and the risk assessment slice are partitioned into non uniform-shaped cells.

12. A method for possible worlds risk assessment, the method comprising:
creating a plan for each risk source which threatens a defended area in one or more possible worlds;
clustering states of each plan for each risk source by spatial locality to generate a risk source slice for each plan;
partitioning each risk source slice into cells representing the risk to a defended area for each plan in each of the one or more possible worlds, each cell of each risk source slice including a probabilistic representation of each risk source for each plan;
combining corresponding cells of each risk source slice to generate a risk assessment slice including an assessment of the risk associated with each cell of each risk source slice to provide a situational assessment of the risk to a defended area across the one or more possible worlds; and
storing each risk source slice and the risk assessment slice in a data grid.

13. The method of claim 12 further including the step of partitioning the risk assessment slice is into cells.

14. The method of claim 12 further including the step of evaluating each cell of each risk source slice to determine a threat risk assessment for each cell.

15. The method of claim 14 further including the step of combining evidence from matching cells of each risk source slice into an appropriate cell of the risk assessment slice.

16. The method of claim 13 further including the step of storing each risk source slice and the risk assessment slice in different levels of the data grid.
